(19) United States
(12) Patent Application Publication
(10) Pub. No.: US 2004/0199320 A1
(43) Pub. Date: Oct. 7, 2004

(54) Drive system changing device and method/program thereof

(75) Inventor: Kunio Harada, Hiroshima (JP)

Correspondence Address: LINIAK, BERENATO & WHITE, Suite 240, 6550 Rock Spring Drive, Bethesda, MD, 20817, US

(73) Assignee: Kabushiki Kaisha Haradakuni

(21) Appl. No.: 10/728,749

(22) Filed: Dec. 8, 2003

(30) Foreign Application Priority Data
Apr. 3, 2003 (JP) 2003-100419

(51) Int. Cl. G06F 7/70

(52) U.S. Cl. 701/69; 701/70

(57) ABSTRACT

A drive system changing device actuated in an emergent operation is characterized by having a vehicle speed detecting means detecting a vehicle speed before a deceleration start; a deceleration detecting means detecting a negative acceleration due to a sudden braking; a steering angle detecting means detecting a steering angle when a sudden operation is performed in the sudden braking; a determination means determining whether or not to change a drive system from a result obtained from each means of the above detecting means; a driving force separating means changing a four wheel drive system to front/rear wheel drive systems by separating a part of driving force transmitting unit of the four wheel drive system according to a determination of the determination means; and a drive system returning means returning the drive system changed to the front/rear wheel drive systems after the emergent operation by the separating means to the four wheel drive system.

### FIELD OF THE INVENTION

The present invention relates to a drive system changing device of a four wheel drive vehicle, and in more particular, relates to the drive system changing device to enhance running stability in emergent operations such as a sudden braking and sharp turning.

### BACKGROUND OF THE INVENTION

Although conventionally to improve safety in emergent operations such as a sudden braking and sharp turning of an automobile and an accident, for example, a safety measure such as an antilock brake system (ABS) and air bag are taken, a casualty due to a traffic accident shows no sign of significant decline notwithstanding these safety measures being implemented. The National Highway Traffic Safety Administration (NHTSA) indicates that especially a sport utility vehicle (SUV) of a four wheel drive system (4WD: four wheel drive) is higher in a ratio of a roll over (not less than 60 percent of SUV accidents accompany the roll over) compared with an ordinary vehicle, and moreover, a ratio of its passengers being killed by roll over accidents is as about triple high as that of the ordinary vehicle.

Many automobiles are lighter at their rear portions in their structures with engines and the like being placed at front portions of their vehicles, thereby the front portion being heavier, and adopt a system by driving rear wheels (FR: Front engine Rear drive) and another system by driving front wheels (FF: Front engine Front drive), and then many the SUVs adopt a 4WD.

Because the ordinary vehicle is, as described above, heavier at the front portion and is lighter at the rear portion in its structure, a phenomenon in which the vehicle rear portion is swung by inertial force in a front direction and lateral direction making front wheels of the vehicle a base point is difficult to occur even in emergent operations if the rear portion is in a lighter state. But when there are many passengers and a weight of cargo on board is heavier, the vehicle rear portion becomes heavier, so the phenomenon in which the vehicle rear portion is swung by inertial force in the front direction and lateral direction making the front wheels of the vehicle the base point is easy to occur. And this is one of factors of a spin and roll over.

Here, considering the roll over, it is largely classified into a tripped roll over and handling roll over. Being described by a simple mechanism, the tripped roll over occurs as shown in FIGS. 4A to 4C by impact force changing to angle momentum when a vehicle with a lateral speed hooks a tire on an obstacle such as a curb stone. For example, when the impact force of a vehicle with a mass m and gravity center h_{cg} laterally sliding at a speed V_{y} is converted to the angle momentum, it can be expressed in an equation (1) described below (see FIGS. 4A and 4B):

mq²*φ=mv_{y}h_{cg}, (1)

where m is a weight of a vehicle, V_{y} is a lateral sliding speed, h_{cg} is a height of gravity center of the vehicle, q is a distance between a position of the gravity center and tire, and φ is an angle in the case that the position of gravity center of the vehicle is converted to a rotation movement.

In addition, a condition of the roll over in the case can be expressed in an equation (2) described below (see FIG. 4C):

mg(q−h_{cg})<(mq²*φ²)/2, (2)

where q=√(h²_{cg}+(b/2)²) and g is gravitational acceleration.

On the other hand, the handling roll over happens when very large rapid steering is performed on a dry flat road and emergent operations are performed. The handling roll over often happens in the SUV of which gravity center is comparatively high, and is easy to occur when a double change and J turn (step steering with a large steering angle and angular rate) are performed at a high speed running in a high way and the like.

As a specification relating to these roll overs, a ratio of a tread and gravity center height (b/h_{cg}) exists and a condition of the roll over in the case can be expressed in an equation (3) described below (see FIG. 5):

b/2h_{cg}<ma_{y}/mg, (3)

where b is a width of a tread and a_{y} is a speed in a traveling direction of a vehicle. Meanwhile, the tread is a center distance (meter) of left/right tread contacting surfaces with a road surface, that is, a distance between wheels.

In other words, in the above equations (2) and (3) when left part values are greater than right part values, the roll over does not happen, but when the right part values exceed the left part values, the roll overs happen, respectively. Out of the roll overs, as for the tripped roll over, because various occurrence factors such as an accident, snowy road, and muddy road exist, it is very difficult to prevent it; as for the handling roll over, it is thought that an occurrence of the roll over can be restrained by a measure of some kind being taken.

Here, one of occurrence causes of the handling roll over in the SUV of the 4WD is considered. Usually, when an automobile turns, rotation differences produce among four tires, so a differential gear is equipped in order to eliminate such the rotation differences and lighten a load on each tire. In the differential gear, there exist a front differential gear to eliminate a rotation difference between front wheels and a rear differential gear to eliminate a rotation difference between rear wheels. In addition, especially in a 4WD vehicle (especially full-time 4WD vehicle), because the rotation difference occurs in turning, running on a bad road, and the like between front and rear wheels, a center differential gear is adopted to eliminate this.

To actuate each the differential gear, a resistance has to occur between tires and a road surface, so if the rotation difference between the front and rear wheels is eliminated with the center differential gear being equipped and a tire load is achieved to be alleviated, a vehicle body exceeding as many as one tonnage running at a high speed and a resistance inside the differential gear to eliminate the rotation difference become a big load for the tires in question.

In addition, in the full-time 4WD because a drive system is mechanically connected, driving force from an engine is also transmitted to each tire even in braking.

Especially, because many SUVs attach high tires in a height of side wall (SW) of a tire, a big load is given to an outer front tire in turning due to the tire load and driving force described above when emergent operations accompanying a sudden braking and sudden steering operation are performed. When such the load exceeds a strength of side wall SW of the outer front tire in turning, a tire shape instantaneously distorts largely and results in a state of an abnormal deformation (see FIG. 6). And resulting in the abnormally deformed state, the vehicle becomes a state to be unoperable, and in a worst case, it results in the handling roll over described above.

But even in such the SUV, if passengers are a few and a weight of cargo on board is lighter (a front portion being heavier and a rear portion being lighter) even in the case of the emergent operations from the high speed, the vehicle weight is comparatively light, thereby the load for the outer front tire in turning becoming comparatively light, and the SUV is difficult to result in the abnormal deformed state such as a section drawing showing an abnormal deformed condition of the outer front tire in turning in the emergent operations in FIG. 6. Therefore, it is statistically known that the roll over accidents due to the handling roll over does not comparatively occur. In other words, it can be said that the handling roll over especially described above tends to occur when the emergent operations are performed from the high speed in a state with many passenger and the weight of cargo on board is heavier (state in which a vehicle rear portion is heavier).

On the other hand, in the FF vehicle and FR vehicle because the driving force is not connected between the front and rear wheels, a problem specific for the 4WD does not occur and the abnormal deformation of the outer front tire in turning described above is difficult to be caused, thereby the handling roll over accidents being a few even when passengers are more and the weight of cargo on board is heavier.

That is, even when the passengers are more and the weight of the cargo on board is heavier, it is thought that the safety is improved if the 4WD is temporary changed to a front wheel 2WD and rear wheel 2WD (2WD: two wheel drive) in the emergent operations.

Here, as a method temporary changing the 4WD to the front wheel 2WD and rear wheel 2WD, a 4WD system of a so called part-time system changed by manual and another system changed by electronic control (for example, see Japan patent laid open publication 5-131856) are known.

But the system changed by the electronic control in the Japan patent is a driving force distribution controller of a four wheel drive vehicle which usually drives with two wheels of the FF and FR, and electronically controls a transmission torque to other wheels making one set of the front/rear wheels a drive base when front tires and rear tires other than driven wheels tend to slip. Such the system performs an acceleration turn and the like in running of the 2WD, and when a movement condition of the vehicle reaches a limit alarm region, the drive system is made to the 4WD, thereby improvement of a limit foreseeing ability and limit controllability being achieved regardless of variations of a road surface friction coefficient; the system is not intended to change the 4WD to the 2WD of the FF and FR in the emergent operations.

For the SUV of the 4WD, in order to enhance the safety in the emergent operations, it is thought that improvement of a tire durability, braking performance, and some other measures are requested.

### SUMMARY OF THE INVENTION

The present invention is originated focusing attention on the problems described above, and its exemplary object is to provide a drive system changing device which is temporary changed to a front wheel drive system and rear wheel drive system in emergent operations of an automobile (vehicle) running with a four wheel drive system.

The present inventor has studied hard to solve the problems and discovered that roll over accidents due to the handling roll over can be prevented by temporary changing the four wheel drive (4WD) system to the front wheel drive (FF) system and rear wheel drive (FR) system in the emergent operations of a vehicle running with the 4WD system, thereby resulting in completion of the invention.

Meanwhile, in the invention the “emergent operations” means to perform sudden braking and steering operations and can be prescribed by a speed, time, steering angle, and the like in the emergent operations. In addition, the “sudden braking” means to perform the sudden braking operation by brake. A “in the sudden braking” means time when acceleration exceeds a negative threshold by the sudden braking operation (for example, −0.8 to −1.0 G) and to detect such the threshold, for example, a G sensor and a speedometer of the vehicle can be used. Moreover, the “sudden steering” means that an operation in which a steering angle of front tires by the steering operation in a relationship with the speed becomes over a constant angle is performed: especially in the invention, the steering angle in which the front tires abnormally deforms in performing the sudden steering operation at a certain speed is made an upper limit, and the steering angle is measured by each speed with an experiment and the like, thereby such the angles being able to be defined as an alarm range. Still furthermore, an “after the emergent operations” means a state in which both and either one of such the operations are eliminated after the sudden braking and steering operations are judged to be performed. In addition, a “prescribed weight” means, for example, a dry weight of a weight described in a vehicle inspection certificate, and a “weight in running” can mean a weight identified at a start of an engine and that identified as needed in running, that is, a weight in which a weight of passengers, weight of cargo on board, fuel, and other devices are added to the prescribed weight.

A first aspect of the invention exists in a drive system changing device which is actuated in emergent operations and is characterized by having a vehicle speed detecting means detecting a vehicle speed before a start of deceleration; a deceleration detecting means detecting a negative acceleration due to a sudden braking; a steering angle detecting means detecting a steering angle when a sudden steering operation is performed in the sudden braking; a determination means determining whether or not to change a drive system from a result obtained from each means of the vehicle speed detecting means, deceleration detecting means, and steering angle detecting means; a driving force separating means changing a four wheel drive system to a front wheel drive system and rear wheel drive system by separating a part of driving force transmitting unit of the four wheel drive system according to a determination of the determination means; and a drive system returning means returning the drive system changed to the front wheel drive system and rear wheel drive system by the determination means to the four wheel drive system after the emergent operations.

The drive system changing device of first aspect of the invention, in the emergent operations due to the sudden braking and handling of a vehicle, especially the SUV, detects the vehicle speed just before the sudden braking, then detects the negative acceleration due to the sudden braking, and moreover detects the steering angle when a handle is operated in the sudden braking. From a result detecting each the operation, the device determines whether or not an alarm level in the emergent operations expected in advance is reached, and in its determination, when it is determined that the alarm level in the emergent operations expected in advance is reached, the driving force separating device is actuated and the vehicle running in the 4WD can be changed to one of the FR and FF by separating the part of the driving force transmitting unit which transmits the driving force to the four wheels. In addition, because an abnormal deformation of an outer front tire in turning in the emergent operations can be prevented thanks to this, resultingly a prevention of a roll over occurrence and improvement of running stability in the emergent operations can be achieved. Moreover, by connecting the driving force transmitting unit after the emergent operations, the device system can again return to the four wheel drive system.

A second aspect of the invention exists in the drive system, changing device described in the first aspect of the invention, which is characterized in that the determination means is controlled by an electronic determination device.

The second aspect of the invention allows accurate and speedy control of the drive system changing device to be performed because the control of the drive system changing device is performed by the electronic controller.

A third aspect of the invention exists, in the first aspect of the invention, in a drive system changing device characterized by furthermore having a vehicle weight detecting means detecting a difference between a vehicle weight in running and prescribed one, and a drive system change-actuation judgment means which actuates the device only when an increment of the vehicle weight detected by the vehicle weight detecting means is more.

The third aspect of the invention enables, in the first aspect of the invention, the drive system change to be performed by the drive system changing device of the invention with detecting the vehicle weight prescribed according to vehicle kinds and the difference of increment of the vehicle weight due to passengers in running and the like when the emergent operations are performed only in the case of increment of the vehicle weight being more as in such a case that the passengers are more and a weight of cargo on board is heavier. That is, when the increment of the vehicle weight is less, the drive system change by the drive system changing device related to the invention is not performed and the emergent operations can be performed as the 4WD is.

A fourth aspect of the invention is a drive system changing method actuated in the emergent operations and exists in the method characterized by consisting of a vehicle speed detecting step detecting a vehicle speed before a start of deceleration, a deceleration detecting step detecting a negative acceleration due to a sudden braking; a steering angle detecting step detecting a steering angle when a sudden steering operation is performed in the sudden braking; a determination step determining whether or not to change a drive system from a result obtained from each step of the vehicle speed detecting step, deceleration detecting step, and steering angle detecting step; a driving force separating step changing the four wheel drive system to a front wheel drive system and rear wheel drive system by separating the part of driving force transmitting unit of the four wheel drive system according to a determination of the determination step; and a drive system returning step returning the drive system changed to the front wheel drive system and rear wheel drive system by the driving force separating step to the four wheel drive system after the emergent operations.

The fourth aspect of drive system changing method of the invention, in the emergent operations due to the sudden braking and steering operations, detects each the operation by a step detecting the vehicle speed just before the sudden braking, then a step detecting the negative acceleration due to the sudden braking, and moreover a step detecting the steering angle when a handle is operated in the sudden braking; whereby the method can determine whether or not an alarm level is reached in the emergent operations expected in advance; and in its determination steps, when it is determined that the alarm level in the emergent operations expected in advance is reached, the method changing a vehicle running in the 4WD to one of the FR and FF by the driving force separating step separating the part of driving force transmitting unit of the vehicle can be realized. In addition, because an abnormal deformation of an outer front tire in turning in the emergent operations can be prevented according to this, resultingly a prevention of a roll over occurrence and improvement of running stability in the emergent operations can be achieved. Moreover, after the emergent operations by the drive system returning step connecting the driving force transmitting unit separated by the drive system separating step, the four wheel drive system can be again returned.

### BRIEF DESCRIPTION OF THE DRAWINGS

FIG. 1 is an illustration drawing showing one of embodiments of a drive system changing device related to the invention.

FIG. 2 is a flowchart of a drive system changing method related to the invention.

FIG. 3 is a flowchart of a program for a drive system changing device related to the invention.

FIGS. 4A, 4B, and 4C are drawings showing appearances of a tripped roll over and its dynamic actions: FIG. 4A is a drawing in which a vehicle is laterally sliding; FIG. 4B is a drawing at an instant when a tire has clashed an obstacle; and FIG. 4C is a drawing of the roll over proceeding.

### DESCRIPTION OF THE PREFERRED EMBODIMENTS

Hereinafter, one of embodiments of the present invention will be described in detail, referring to drawings as needed, however it goes without saying that the substance of the invention is not limited to this and is also applicable changed as needed as far as it is not deviated.

A “drive system changing device” of the invention being, for example, described referring to an illustration illustrating a drive system changing device 1, any drive system changing device is available if it has a vehicle speed detecting means (vehicle speed detector 5: for example, a speedometer) detecting a vehicle speed before a start of deceleration; a deceleration detecting means (deceleration detector 6: for example, a G sensor) detecting a negative acceleration due to a sudden braking; a steering angle detecting means (steering angle detector 7: for example, a rack displacement amount detector) detecting a steering angle when a sudden steering operation is performed in the sudden braking; a determination means (electronic controller 3: for example, a microcomputer) determining whether or not to change the drive system from a result obtained from each the means; a driving force separating means (driving force separating device 2: for example, a clutch) changing the four wheel drive system to the front wheel drive system and rear wheel drive system by separating the part of the driving force transmitting unit according to a determination of the determination means (electronic controller 3); and a drive system returning means (drive force separating device 2) returning the drive system, which is changed to the front wheel drive system and rear wheel drive system by the driving force separating means (driving force separating device 2), to the four wheel drive system. Moreover, the drive system changing device may have a vehicle weight detecting means (vehicle weight detector 4: for example, a hydraulic sensor) detecting a difference of a vehicle weight between a prescribed weight and one in running; and a drive system change-actuation judging means (electronic controller 3) judging the driving force separating means (driving force separating device 2) to make non actuation in the case that an increment of the vehicle weight detected by the vehicle weight detecting means (vehicle weight detector 4) is less.

Although the “vehicle speed means” of drive system changing device of the invention is not specifically limited, the speedometer continuing on always detecting a speed in a running state and an electronic controller continuing on monitoring the speed in conjunction with the speedometer can be concretely cited. In addition, as the “deceleration detection means”, anything may be available if it detects deceleration per unit time decelerated by a sudden braking operation from a running speed detected by the vehicle speed detecting means, and for example, it can be concretely cited to detect the deceleration of a vehicle in conjunction with the speedometer, and for example, to detect the deceleration by the G sensor. As the “steering angle detecting means, anything is available if it detects a tire cutting angle steered by a steering operation in the sudden braking, and for example, it can be cited to equip a device detecting a steering angle of a handle in the emergent operations in cooperation with the handle and to equip another device (rack displacement amount detector) detecting a displacement amount of a rack in a steering gear.

The “determination means” of the invention can judge, in the “electronic controller” including a program executable by the electronic controller described in detail later, by information obtained from the vehicle speed detecting means, deceleration detecting means, and steering angle detecting means whether or not the information is an emergent operation, whether or not the deceleration exceeds a threshold, and whether or not the steering angle reaches an alarm level in the emergent operations.

Moreover, the “driving force separating means” is not specifically limited, however, for example, when it is judged that to change the drive system is requested by the determination means (electronic controller), followings can be concretely cited: the driving force separating means transmits a signal to a hydraulic unit 8 from the electronic controller; actuates a clutch-like mechanism by actuating the hydraulic unit 8; and cuts one of driving force of front wheels and rear wheels, thereby transmitting the driving force to only either two wheels of the front and rear wheels. Meanwhile, the clutch-like mechanism includes, for example, a clutch, gear, and the like as a device having a mechanism which can cut the driving force between the front and rear wheels.

The “drive system returning means” of drive system changing device of the invention can return, when it is determined that the emergent operations are eliminated by the determination means, the driving force cut by the clutch mechanism to the 4WD system automatically by electronic control, and the drive system from the FR and FF systems to the 4WD system semi-automatically by a switch and the like.

Meanwhile, as the “vehicle weight detecting means” in the drive system changing device of the invention, anything may be available if it is a means which can detect the vehicle weight and it is not specifically limited, however a means calculating an attenuation value due to sinking-down of a shock absorber occurring in getting on a vehicle by the hydraulic sensor attached to the shock absorber and an increment of the vehicle weight from a hydraulic pressure can be cited.

In addition, as the “drive system change-actuation judging means,” anything is available if it is a means which, when the increment of the vehicle weight detected by the vehicle weight detecting means is more, judges to actuate the drive system changing device; and when the increment of the vehicle weight detected by the vehicle weight detecting means is less, judges not to actuate the drive system changing device. To be more precise, such the judgment can be made to be performed by the “electronic controller” including a program executable by the electronic controller described in detail later. Accordingly, the drive system change-actuation judging means is thought to detect/judge a difference between the prescribed weight and one in running from a dry weight of a vehicle described in the vehicle inspection certificate and the like by the vehicle weight detecting means and drive system changing device as: when the vehicle weight increases, for example, over 250 kg, an increment of the vehicle weight is uniformly “more”; and when the vehicle weight exceeds 1.3 folds of dry weight of the vehicle, the increment of the vehicle weight is “more.” When judged as such “more,” a judgment to change the drive system in the emergent operations according to the invention can be performed, and when the increment of the vehicle weight is detected as “less,” another judgment not to change the drive system according to the invention can be performed.

Here, as the “program” used for the drive system changing device, any program is available if in the invention it is composed as a program which can realize to temporary change a running system to the FR and FF systems from the 4WD system in the emergent operations, based on information obtained from the vehicle speed detecting means, deceleration detecting means, and steering angle detecting means. Meanwhile, a program language composing such the program may be anything, is not specifically limited, and any language used for a usual program such as an assembler, FORTRAN, COBOL, BASIC, C/C++, Java (R), Java (R) Script, and Perl is available.

As a recording medium to record the program described above, anything is available if it can record the program, and although not specifically limited, a semiconductor device can be concretely cited.

Here, in the drive system changing device, as the “electronic controller” including the program executable by the electronic controller, anything is available if it is an electronic controller which can acquire each data such as the vehicle weight increment, vehicle speed, deceleration, and steering angle obtained from the above; perform a computation according to the program; and perform each the judgment: to be more precise, a usually used microcomputer and the like can be cited as a concrete example.

Meanwhile, in the electronic controller which can execute the program recorded in the program for the drive system changing device, positions of the gravity center, roll center, and the like are calculated from the vehicle weight, acceleration, speed, deceleration, and the like by the electronic controller, and moreover considering results such as the positions of the gravity center and roll center, the presence or absence of a driving force change may be judged.

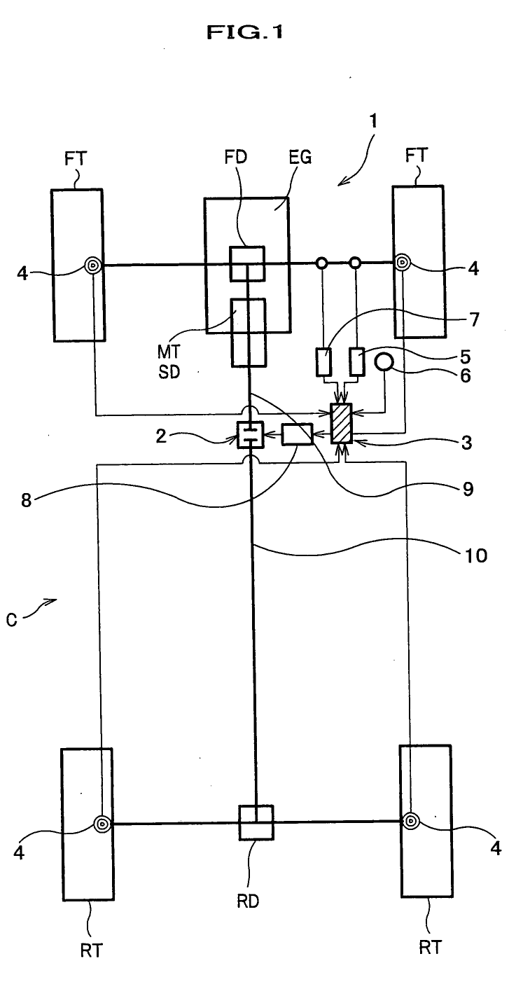

Next, one of embodiments related to the invention will be described in detail, referring to an illustration illustrating a system of the drive system changing device shown in FIG. 1.

Firstly, in the full-time 4WD shown in FIG. 1, such a vehicle C detects the increment of the vehicle weight according to passengers and a weight of cargo on board by the vehicle weight detector 4 attached as the vehicle weight detecting means to a shock absorber, and the detector 4 outputs the data in the electronic controller 3 as the judgment means. In addition, in conjunction with the speedometer the vehicle C detects a vehicle speed as needed by the vehicle speed detector 5 to detect the vehicle speed as the vehicle speed detecting means, and the detector 5 outputs such the data likewise as above in the electronic controller 3 as the judgment means. Moreover, in the embodiment the deceleration detector 6 is disposed as the deceleration detecting means detecting deceleration by the G sensor, can detect the deceleration in a sudden braking, and outputs such the data likewise as above in the electronic controller 3. In addition, in cooperation with the handle, the steering angle detector 7 detecting the steering angle of tires is provided, detects the steering angle of the tires, and outputs such the data likewise as above in the electronic controller 3. And the electronic controller 3 as the judgment means judges whether or not to change the drive system from each the data of the vehicle weight increment, vehicle speed, deceleration, and steering angle. Meanwhile, such the electronic controller 3 is an electronic controller which has a program for the drive system changing device not shown in the drawing, and based on information (information whether or not to change the drive system in the emergent operations from a relationship between the deceleration and steering angle) recorded in such the program in advance, can execute the program of the drive system change. And as a result of the above judgment, when it is judged that the drive system is requested to be changed, according to the program the electronic controller 3 transmits a signal to actuate the driving force separating device 2 to the hydraulic unit 8; actuates the hydraulic unit 8; and separates a front drive shaft from a rear drive shaft with a clutch having the driving force separating device 2, thereby being able to cut the driving force of the rear wheels at an instant and to make a state of running only with two wheels of the front. Meanwhile, after the emergent operations, according to the program the electronic controller 3 transmits a signal to return the drive system to the hydraulic unit 8 in order to actuate the driving force separating device 2 as the drive system returning means, actuates the driving force separating device 2, and again connects the clutch, thereby being able to return one of two wheel drive systems of the front and rear to the 4WD system.

Meanwhile, in FIG. 1 an FT represents a front tire; an RT, a rear tire; an FD, a front differential; an SD, a center differential; an RD, a rear differential; an MT, a mission; and an EG, an engine, respectively.

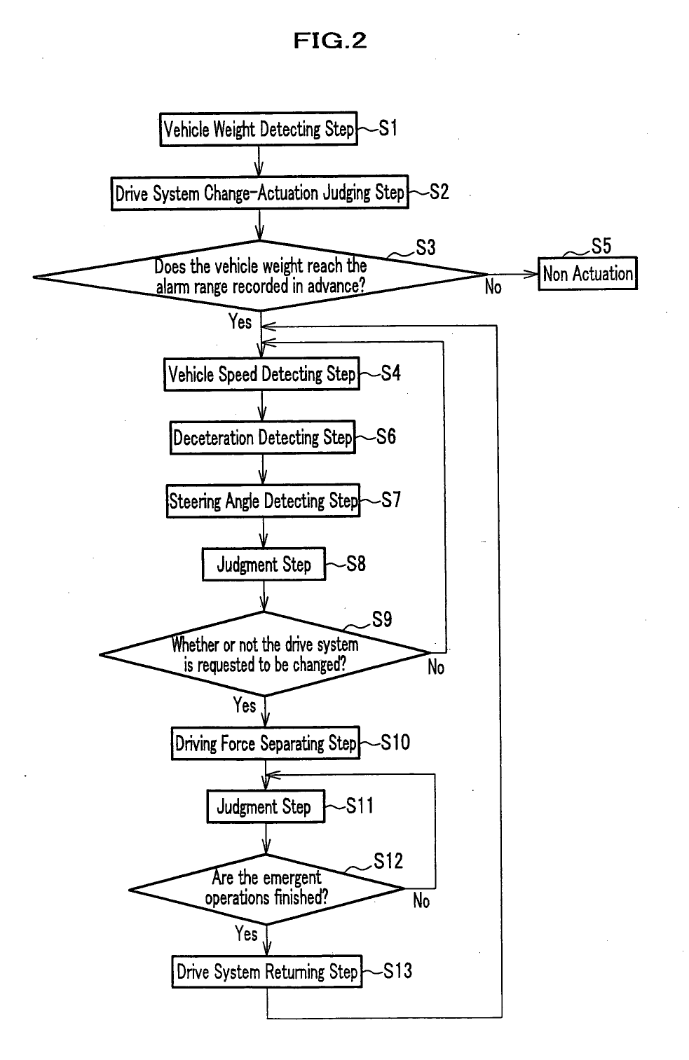

Next, referring to a flowchart shown in FIG. 2, the drive system changing method related to the invention is described. Although in FIG. 2 a vehicle weight detecting step and drive system change-actuation judging step (S2) are included, the drive system changing method firstly detects the increment of the vehicle weight due to passengers and a weight of cargo on board by the vehicle weight detecting step (S1). Then, judge “whether or not the vehicle weight reaches an alarm range recorded in advance” (S3) by the drive system change-actuation judging step (S2), and when judged to be lighter (No), do not move to steps after the drive system change-actuation judging step (S2) and make non actuation (S5), thereby the drive system changing method of the invention being not performed. On the other hand, when judged to be heavier (Yes), a vehicle speed in its running is detected as needed by a vehicle speed detecting step (S4). Meanwhile, when the vehicle weight detecting step (S1) and drive system change-actuation judging step (S2) are not used, the program related to the invention is assumed to start from the vehicle speed detecting step (S4).

And detect deceleration due to a sudden braking in the emergent operations by a deceleration detecting step (S6), additionally detect a steering angle of front tires simultaneously by a steering angle detecting step (S7), perform a computation based on information recorded in advance from a relationship between the deceleration and steering angle, and judge whether or not a state of the front tires reaches the alarm range by the electronic controller of a judgment step (S8). Judging from a judgment result by the judgment step (S8) “whether or not the drive system is requested to be changed,” (S9) when the drive system is not requested to be changed (No), continue on monitoring a vehicle state again looping to the vehicle speed detecting step (S4). On the other hand, when judged that the drive system is requested to be changed (Yes), actuate a driving force separating step (S10) and change the vehicle running with the 4WD system to a system driving with the two wheels of the front and rear wheels. And in a judgment step (S11) by the electronic controller, judge “whether or not the emergent operations are finished,” (S12) and when judged that the emergent operations are finished, “Yes,” return the drive system to the 4WD system by a drive system returning step (S13), and again after then, continue on monitoring the state of the front tires looping to the vehicle speed detecting step (S4). On the other hand, when judged that the emergent operations are not finished (No), make a confirmation till the finish of the emergent operations looping to the judgment step (S11) until the emergent operations are finished.

Meanwhile, although the drive system changing method is described as a method in which the vehicle speed detecting step (S4), deceleration detecting step (S6), and steering angle detecting step (S7) as sequentially processed, it goes without saying that these processes may be parallel and concurrently processed.

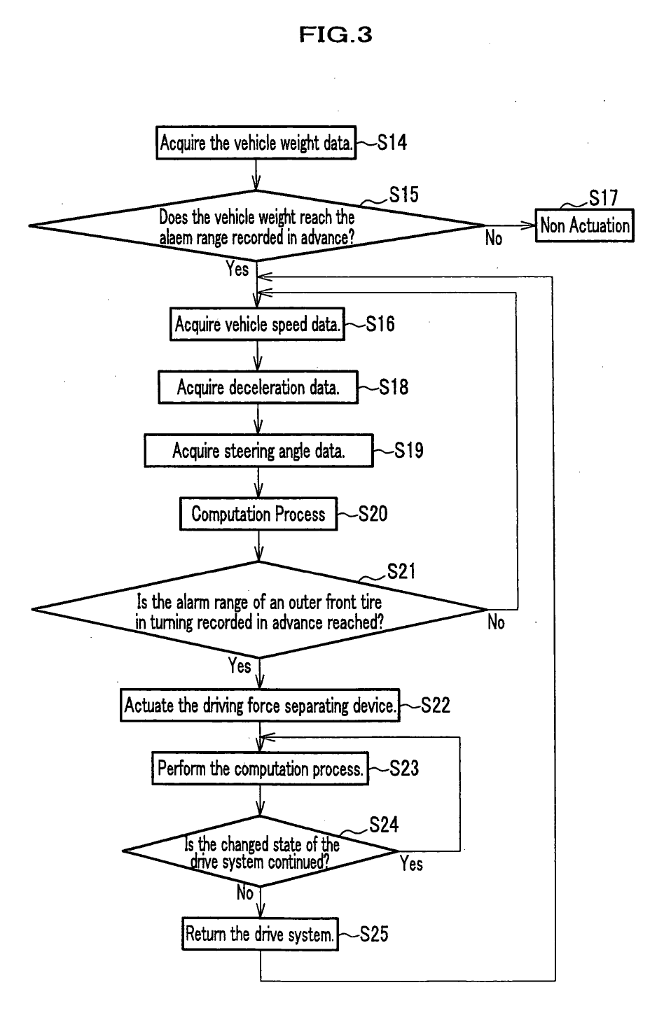

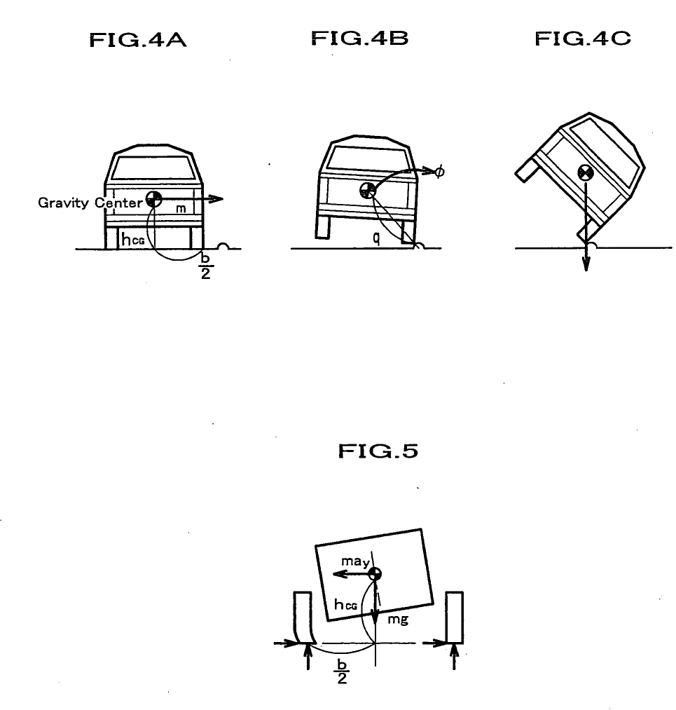

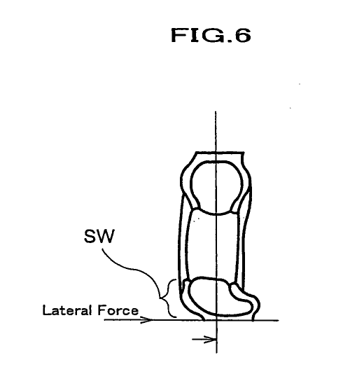

In addition, the program is described referring to a flowchart shown in FIG. 3. FIG. 3 includes a program relating to the vehicle speed detecting means and drive system change-actuation judging means, and if the program is executed, the electronic controller acquires vehicle weight data from the vehicle weight detecting means (S14). Then, the program makes the electronic controller judge from the acquired vehicle weight data “whether or not the vehicle weight reaches the alarm range recorded in advance” (S15) by a computation, and when the increment of the vehicle weight is less, the program makes the electronic controller transmit a signal to make “non actuation” (S17) to the driving force separating device. On the other hand, when the increment of the vehicle weight is more, the program makes the electronic controller acquire vehicle speed data from the vehicle speed detecting means in running (S16), makes it acquire deceleration data in a sudden braking (S18), and also makes it acquire sudden steering angle data then (S19). And the program makes the electronic controller perform a computation based on each the acquired data (S20), makes it judge “whether or not an alarm range of an outer front tire in turning recorded in advance is reached” (S21), and when the alarm range is reached (Yes), makes it transmit a signal to actuate the driving force separating device related to the invention (S22). On the other hand, when the alarm range is not reached (No), the program does not make the electronic controller transmit a signal to change the drive system and again makes it acquire data such as the vehicle speed (S16 to S19). When actuating the driving force separating device (S22), the program makes the electronic controller perform a computation (S23), makes it judge “whether or not continue a changed state of the drive system” (S24), and when judged that continuing is requested (Yes), makes it continuously maintain the changed state and repeat the computation (S23) until the state is not requested. On the other hand, when judged that continuing is not requested (No), the program makes the electronic controller return the drive system to the 4WD system and again acquire the vehicle speed data and the like (S16 to S19). Meanwhile, although the above program is described as a program making the electronic controller acquire the vehicle data (S16), acquire the deceleration data (S18), and acquire the steering angle data (S18) as sequentially processed, it goes without saying that these processes may be parallel and concurrently processed.

What is claimed is:

1. A drive system changing device actuated in an emergent operation, the device comprising:
a vehicle speed detecting means detecting a vehicle speed before a start of deceleration;
a deceleration detecting means detecting a negative acceleration due to a sudden braking;
a steering angle detecting means detecting a steering angle when a sudden steering operation is performed in the sudden braking;
a determination means determining whether or not to change a drive system from a result obtained from each means of said vehicle speed detecting means, said deceleration detecting means, and said steering angle detecting means;
a driving force separating means changing a four wheel drive system to a front wheel drive system and a rear wheel drive system by separating a part of a driving force transmitting unit of the four wheel drive system according to a determination of said determination means; and
a drive system returning means returning the drive system changed to the front wheel drive system and the rear wheel drive system after the emergent operation by said driving force separating means to the four wheel drive system.

2. A drive system changing device according to claim 1, wherein said determination means is controlled by an electronic controller.

3. A drive system changing device according to claim 1, the method furthermore having:
a vehicle weight detecting means detecting a difference between a prescribed vehicle weight and a vehicle weight in running; and
a drive system change-actuation judging means actuating said drive system changing device only when an increment of the vehicle weight detected by said vehicle weight detecting means is more.

4. A drive system changing device according to claim 3, wherein said drive system change-actuation judging means is controlled by an electronic controller.

5. A drive system changing method actuated in an emergent operation, the method comprising the steps of:
a vehicle speed detecting step detecting a vehicle speed before a start of deceleration;
a deceleration detecting step detecting a negative acceleration due to a sudden braking;
a steering angle detecting step detecting a steering angle when a sudden steering operation is performed in the sudden braking;
a determination step determining whether or not to change a drive system from a result obtained from each step of said vehicle speed detecting step, said deceleration detecting step, and said steering angle detecting step;
a driving force separating step changing a four wheel drive system to a front wheel drive system and a rear wheel drive system by separating a part of a driving force transmitting unit of the four wheel drive system according to a determination of said determination step; and
a drive system returning step returning the drive system changed to the front wheel drive system and the rear wheel drive system after the emergent operation by said driving force separating step to the four wheel drive system.

6. A drive system changing method according to claim 5, the method further comprising the steps of:
a vehicle weight detecting step detecting a difference between a prescribed vehicle weight and a vehicle weight in running;
wherein only when an increment of the vehicle weight detected by said vehicle weight detecting step is more, said determination step is a determination step to determine whether or not to change a drive system from a result obtained from each step of said vehicle speed detecting step, said deceleration detecting step, and said steering angle detecting step.

7. A program executable by an electronic controller according to claim 2 controlling a drive system changing device, the program making the electronic controller:
monitor a vehicle speed as needed by acquiring detected and output data by said vehicle speed detecting means;
monitor deceleration in a sudden braking by acquiring detected and output data by said deceleration detecting means;
monitor a steering angle detecting means by acquiring detected and output data by said steering angle detecting means;
perform a computation whether or not an alarm range recorded in advance is reached based on each data monitored by said deceleration detecting means and said steering angle detecting means;
actuate said driving force separating device when as a computation result a state of front tires due to an emergent operation is judged to be in the alarm range recorded in advance, and transmit a signal to change a four wheel drive system to a two wheel drive system; and
actuate said driving force separating device again after the emergent operation, and transmit a signal to return the two wheel drive system to the four wheel drive system.

8. A program executable by an electronic controller according to claim 4 controlling a drive system changing device, the program further making the electronic controller:
judge whether or not an increment of a vehicle weight reaches an alarm range recorded in advance by acquiring data detected by said vehicle weight detecting means; and
transmit a signal to actuate said driving force separating device when the increment of the vehicle weight reaches the alarm range recorded in advance.
